(19) United States
(12) Patent Application Publication
(10) Pub. No.: US 2025/0061224 A1
(43) Pub. Date: Feb. 20, 2025

(54) ELECTRONIC PROTECTION OF SENSITIVE INFORMATION VIA DATA EMBEDDING AND NOISE ADDITION

(71) Applicant: PAYPAL, INC., San Jose, CA (US)

(72) Inventors: Zijie Poh, San Francisco, CA (US); Siyun Hu, San Jose, CA (US); Wei Li, San Jose, CA (US); Yiwei Li, San Jose, CA (US); Alban Axel Zammit, San Francisco, CA (US); Yucheng Zhang, San Jose, CA (US); Xu Li, San Jose, CA (US); Wei Xu, San Jose, CA (US)

(21) Appl. No.: 18/450,035

(22) Filed: Aug. 15, 2023

(51) Int. Cl. G06F 21/62; G06F 16/27

(52) U.S. Cl. CPC G06F 21/6227; G06F 16/278

(57) ABSTRACT

An electronic file is accessed. The electronic file contains a first type of data that meets one or more specified sensitivity criteria. Via an embedding module, the first type of data is embedded into an electronic database. After the first type of data is embedded, a plurality of requests to query the first type of data is received. Based on the received requests, a noise module adds a different type or amount of noise to the embedded first type of data for each request. The first type of data is outputted after the noise has been added to the first type of data. A machine learning process is performed at least in part based on the outputted first type of data after the noise has been added. An overall characteristic of the first type of data is determined based on a result of the machine learning process.

### BACKGROUND

### Field of the Invention

The present application generally relates to digital data security. More particularly, the present application involves electronically storing sensitive information, such as private user data, in a manner such that the stored sensitive information cannot be retrieved in its original form, thereby enhancing user privacy and data security.

### Related Art

Rapid advances have been made in the past several decades in the fields of computer technology and telecommunications. As a result, these advances allow more and more electronic interactions between various entities. For example, electronic online transaction platforms such as PAYPAL™, VENMO™, EBAY™, AMAZON™ or FACEBOOK™ allow their users to conduct transactions with other users, other entities, or institutions, such as making peer-to-peer transfers, making electronic payments for goods/services purchased, etc. In the course of conducting these transactions, an abundant amount of data may be generated and/or stored. Some of this data may be sensitive, such as a user's private data (e.g., a user's name, address, age, gender, income, phone number, social security number, password, etc.). Certain online entities have employed various techniques to protect the sensitive data. However, existing data protection techniques may still be vulnerable to malicious actors who continually develop methods to overcome current data protection schemes. For example, a malicious actor may use sophisticated machine learning systems executing brute force methods to reverse engineer the sensitive data even after the sensitive data has been supposedly protected. As such, users' sensitive data may be at risk of being divulged, which could result in financial losses, identify theft, and/or user dissatisfaction. Therefore, a need exists to improve existing data protection techniques.

### BRIEF DESCRIPTION OF THE FIGURES

FIG. 1 is a block diagram of a networked system according to various aspects of the present disclosure.

FIG. 2 illustrates an example sensitive data protection process flow according to various aspects of the present disclosure.

FIG. 3 illustrates a graph according to various aspects of the present disclosure.

FIG. 4 illustrates another graph according to various aspects of the present disclosure.

FIG. 5 illustrates yet another graph according to various aspects of the present disclosure.

FIG. 6 illustrates a graph and a table according to various aspects of the present disclosure.

FIG. 7 illustrates a histogram according to various aspects of the present disclosure.

FIG. 8 illustrates an example modeling automation pipeline according to various aspects of the present disclosure.

FIG. 9 illustrates a concept flow and an implementation flow of data protection according to various aspects of the present disclosure.

FIG. 10 illustrates a neural network for machine learning according to various aspects of the present disclosure.

FIG. 11 is a flowchart illustrating a method of data protection according to various aspects of the present disclosure.

FIG. 12 is an example computer system according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to protecting sensitive information via data embedding and noise addition. In more detail, recent advances in the Internet and computer technologies have led to more activities being conducted online. For example, users may purchase products or services from online merchants, engage with each other on social media platforms, stream content (e.g., movies, music, or television shows), manage bank accounts, trade stocks, browse real estate listings, play electronic games, or book trips (e.g., flights, car rides, or lodging), etc. User data may be generated and/or collected in association with these online activities. Some of the user data may be sensitive in nature. For example, sensitive user data may include data that meets one or more specified sensitivity criteria, such as data pertaining to a user's privacy. Non-limiting examples of such data may include a user's name, age, gender, occupation, title, salary, phone number, physical address, email address, health history, date of birth, identifier of a government issued identification document (e.g., a driver's license number or a social security number), answers to security questions (e.g., mother's maiden name, city of birth, name of best friend, high school, etc.), payment instrument information (e.g., credit card number and expiration date), credit score, Internet Protocol (IP) address, shopping history at one or more shopping platforms, etc. In some cases, a user or another entity other than the user may specify various levels of sensitivity thresholds for each type of a plurality of types of data, where each specified level of sensitivity threshold may be associated with a different level of protection.

Due to the sensitive nature of the example types of data listed above, stringent data protection measures are needed to protect the data from being leaked, divulged, hacked, or otherwise accessed in an unauthorized manner. One technique to protect the sensitive data is by hashing the sensitive data via a hashing function. In that regard, a hashing function may be used to mathematically map a character (e.g., an alphanumeric character) to an integer number and/or a string. Through the use of a hashing function, sensitive data may be mapped to a list of numeric values or strings, which in theory should afford a certain level of protection to the original sensitive data. However, data protected by hashing may still be vulnerable to a brute force type of malicious attack. For example, a malicious actor may use computing systems to run through numerous different input combinations to the hash function. Once the malicious actor gets a hash value match, the malicious actor is considered to have cracked the hash function. In this manner, a malicious actor may still gain unauthorized access to the sensitive data in its original form even after the sensitive data has already undergone the hashing protection.

In addition to suboptimal protection, another drawback of the hashing method of protecting sensitive data is that the output of the hashing function (e.g., the hash values in the form of strings) may not be usable for modeling or analytics, at least not practically, since most modeling or analytics techniques are designed to work with numeric values but not necessarily strings that could be the output of the hashing function. Furthermore, the suboptimal protection of sensitive data may lead to challenges in data sharing between various entities. For example, one company may be reluctant to share its users' sensitive data with another company, since the data sharing process and/or the subsequent attempt of protecting the user data by the other company may have various deficiencies, which could lead to the leak of the users' data, thereby resulting in financial damages, identity theft, and/or user dissatisfaction.

To improve the protection of sensitive data, the present disclosure utilizes a combination of data embedding and noise addition to provide ample protection to the sensitive data. For example, an electronic file may be sent to an entity that is tasked with data protection. The electronic file may be provided by another entity that collected and/or generated the sensitive data, such as an online merchant that collected various types of sensitive user data (e.g., name, address, etc.) discussed above during the course of the users' interaction with the online merchant. The sensitive user data may be written, in their original form or with a minimal amount of alteration, into the electronic file.

The data protection entity may access the electronic file, and at a first stage of the data protection, may use an embedding module to apply an embedding function to the sensitive data. In some embodiments, the embedding module may utilize an autoencoder function to apply the embedding function. In other embodiments, the embedding module may utilize a dimension reduction method such as Principal Component Analysis (PCA), or utilize a neural network (NN) by extracting the second to last layer. The embedding generates a unique data output for each individual data input (e.g., a one-to-one mapping) and stores the generated output in an electronic database. The generated output is irreversible (e.g., cannot be converted back to its original form by running the output through another function or algorithm) after being embedded and is inaccessible to an operator of the database. The inaccessibility of the embedded data by the operator of the database means that the embedded is less vulnerable to brute-force type of malicious attacks, since even if a malicious actor gains access privileges of the database operator through nefarious means, the malicious actor still cannot try to reverse engineer the original sensitive data, as the malicious actor does not have the embedded data that would be needed for such a reverse engineering task. In some embodiments, the sensitive data is obfuscated as a part of the embedding process. In some embodiments, the input data may be in a non-numeric-vector format (e.g., as a string, an alphanumeric character, or an image, etc.), and the embedding function converts the non-numeric-vector input data into an output data in a numeric-vector format. That is, the output data after the embedding is comprised of a plurality of numeric vectors.

At a second stage of the data protection, the data protection entity may add noise to the embedded data via a noise module. For example, after the sensitive data has been embedded and stored into the electronic database, the data protection entity may receive a request to query the sensitive data. Based on the received request, the data protection entity may add noise to the data before the data is returned as a part of the query, which is accessible to the operator of the database and/or any entity that has access privileges to the query output. In some embodiments, the noise is added at least in part using a Batching technique, though other types of noise addition techniques may be applicable in other embodiments.

According to the various aspects of the present disclosure, the noise added is different (e.g., different in type or in amount) each time a query request is received. For example, if ten different query requests are received, then the data protection entity may apply a different noise to the data in response to each of the ten requests. As such, from the perspective of any entity accessing the data outputted as a result of the query, ten seemingly different data outputs are generated, even though the seemingly different data outputs all correspond to the same underlying data in actuality. In this manner, the data outputs are no longer vulnerable to the brute force type of malicious attacks. The noise added can also be flexibly tuned to achieve a desired balance between data protection and usability/performance.

Another benefit of the present disclosure is that the data output may be used in modeling and analytics even though it seems random and/or unusable to humans. For example, a machine learning process may be performed at least in part based on the data output after the noise has been added. One or more overall characteristics of the data output (and therefore, the data input) may be extracted based on a result of the machine learning process. For example, the result of the machine learning process may reveal a trend of the users of the online merchant, such as a trend in shopping for a particular product, a trend in the age and/or gender of the users for purchasing a particular product or service, a trend in a geographical location of the users in being victims of fraud, etc. As such, valuable insight can be gained with respect to the users based on the sensitive data associated with the users, while the sensitive aspect of the data (e.g., personal or private information) remains hidden or otherwise undisclosed.

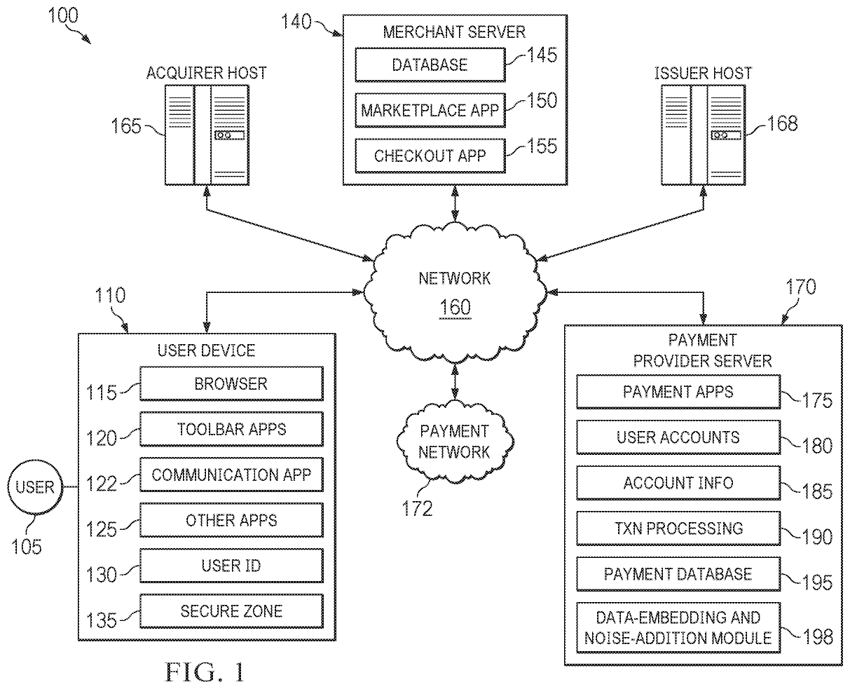

The various aspects of the present disclosure are discussed in more detail below with reference to FIGS. 1-12.

FIG. 1 is a block diagram of a networked system 100 or architecture in which sensitive data may be generated and protected according to embodiments of the present disclosure. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a payment service provider, such as PayPal™, Inc. of San Jose, CA. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products or services offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials or other data that may warrant a more secure or separate storage, including various data as described herein.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

The merchant server 140 may also host a website for an online marketplace. where sellers and buyers may engage in purchasing transactions with each other. The descriptions of the items or products offered for sale by the sellers may be stored in the database 145. For example, the descriptions of the items may be generated (e.g., by the sellers) in the form of text strings. These text strings are then stored by the merchant server 140 in the database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

According to various aspects of the present disclosure, the merchant server 140 (or the entity operating the merchant server 140) may generate and/or collect sensitive information that meets one or more specified criteria. For example, the sensitive information may comprise user data that has been specified as meeting a predefined privacy threshold by the user 105, by the entity operating the merchant server, and/or by another entity. Non-limiting examples of such user data may include the user 105's name, age, gender, occupation, title, salary, phone number, physical address, email address, health history, identifier of a government issued identification document, payment instrument information (e.g., credit card number and expiration date), credit score, Internet Protocol (IP) address, shopping history at one or more shopping platforms, etc. The sensitive information may be stored in the database 145 with some level of protection. However, a greater level of protection is desired for the sensitive information, particularly when situations arise involving the transfer or the sharing of the sensitive information between the merchant server 140 and other entities. Note that although the embodiment of FIG. 1 uses the merchant server 140 as an example entity for generating and or collecting sensitive information, non-merchant types of entities may generate and/or collect sensitive information in other embodiments.

Payment provider server 170 may be maintained, for example, by an online payment service provider that may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a data-embedding and noise-addition module 198 may also be implemented on the payment provider server 170. The data-embedding and noise-addition module 198 may include one or more software applications, software programs, or sub-modules that can be automatically executed (e.g., without needing explicit instructions from a human user) to perform certain tasks. For example, the data-embedding and noise-addition module 198 may electronically access one or more electronic databases (e.g., the database 195 of the payment provider server 170 or the database 145 of the merchant server 140) to access or retrieve electronic data about users, such as the user 105. In some embodiments, the data-embedding and noise-addition module 198 may access an electronic file sent to the payment provider server 170 by the merchant server 140. The sensitive information pertaining to the users of the merchant server 140 may be contained in the electronic file.

In some embodiments, the data is embedded via an encoder function, such that the embedded data may be obfuscated (e.g., the original form of the data cannot be identified). The embedded data may be stored in a database, such as the payment database 195, but in a manner that it is not directly accessible by an operator of the payment database 195. The inaccessibility of the embedded data means that the operator of the payment database 195 (or any malicious actor that has gained access privileges of the operator) cannot reverse engineer the original sensitive data via brute-force type of mechanisms.

Also, according to various aspects of the present disclosure, when a query to access the embedded data is received, noise is added to the embedded data corresponding to the query, for example, via a Batch Inference technique or another suitable noise addition technique. A different type of noise and/or a different amount of noise may be added to the embedded data each time the embedded data is queried. As such, the result of the query—which is available to the operator of the payment database 195—may appear differently each time. In this manner, the noise addition scheme of the present disclosure can sufficiently prevent a brute force type of reverse engineering attack by a malicious actor to gain unauthorized access to the sensitive information in its original form. Consequently, the present disclosure offers an improvement in computer technology, for example, data security and data protection technology. In addition, the query results may be in a numeric vector format, which is well suited for data modeling and/or analytic tasks involving machine learning. Even though each single query result may be clouded by the noise introduced, a large number of queries may still allow machine learning models to extract valuable insight with respect to the characteristics of the underlying sensitive information, while each user's sensitive information is still kept hidden. Hence, the present disclosure also offers an improvement in machine learning, or at least an improvement in a specific technological environment directed to machine learning.

It is noted that although the data-embedding and noise-addition module 198 is illustrated as being separate from the transaction processing application 190 in the embodiment shown in FIG. 1, the transaction processing application 190 may implement some, or all, of the functionalities of the data-embedding and noise-addition module 198 in other embodiments. In other words, the data-embedding and noise-addition module 198 may be integrated within the transaction processing application 190 in some embodiments. In addition, it is understood that the data-embedding and noise-addition module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the data-embedding and noise-addition module 198 may include one or more sub-modules that are configured to perform specific tasks. For example, the data-embedding and noise-addition module 198 may include a data-embedding sub-module that embeds the sensitive information of the electronic file, as well as a noise-addition sub-module that adds noise to the embedded sensitive information.

Still referring to FIG. 1, the payment network 172 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

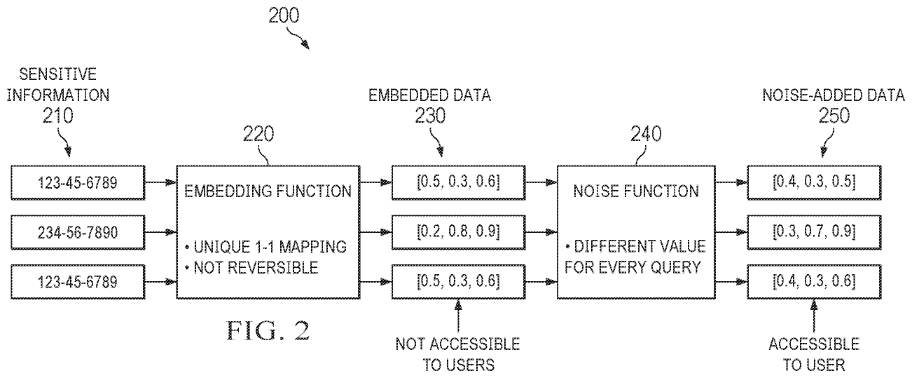

FIG. 2 illustrates an example process flow 200 in which the data-embedding and noise-addition module 198 may be used to perform data embedding and noise addition according to various aspects of the present disclosure. According to the process flow 200, sensitive information 210 may be accessed by a data-embedding sub-module 220 of the data-embedding and noise-addition module 198. The sensitive information 210 may be contained in an electronic file and may include the various types of sensitive attributes of user data discussed above. In the example illustrated in FIG. 2, the sensitive information 210 may include social security numbers (SSNs) of the users of an entity, such as a merchant operating the merchant server 140 of FIG. 1. For reasons of simplicity, three of the SSNs are illustrated: 123-45-6789, 234-56-7890, and 123-45-6789. Note that some of these SSNs may be duplicates of one another, such as the SSN 123-45-6789. The sensitive information 210 may be in a variety of formats. In the illustrated example, the format of the sensitive information 210 is a string. In other examples, the format may include numeric values, alphanumeric characters (not necessarily limited to any particular alphabet), symbols, or images.

The data-embedding sub-module 220 may use a data embedding function to embed the sensitive information 210. In some embodiments, the data-embedding sub-module 220 may utilize an autoencoder as the data embedding function to apply the embedding function. The embedding is performed such that each of the individual data inputs has a unique corresponding embedded output (e.g., a unique 1-to-1 mapping). As a simplified example, the following computer code may be used to implement the autoencoder (assuming that the sensitive attribute is categorical):

```
import tensorflow as tf
from tensorflow.keras import layers, losses
from tensorflow.keras.models import Model
# Load data
# Shape = (number of samples, number of
categories of the sensitive attributes)
data = load_data( )
latent_dim = 64
input_dim = data.shape[1]
class Autoencoder(Model):
  def_init_(self, latent_dim, input_dim):
    super(Autoencoder, self)._init_( )
    self.latent_dim = latent_dim
    self.encoder = tf.keras.Sequential([
      layers.Flatten( ),
    layers.Dense(latent_dim, activation=‘relu’),
    ])
    self.decoder = tf.keras.Sequential([
      layers.Dense(input_dim, activation=‘sigmoid’)
    ])
  def call(self, x):
    encoded = self.encoder(x)
    decoded = self.decoder(encoded)
    return decoded
autoencoder = Autoencoder(latent_dim, input_dim)
autoencoder.compile(optimizer=‘adam’, loss=losses.MeanSquaredError( ))
autoencoder.fit(
    x_train,
    x_train,
    epochs=10,
    shuffle=True
)
# This will get the embedding vector to apply noise to it
embedding_vector = autoencoder.encoder(x).numpy( )
```

In some embodiments with continuous data, the continuous data may be binned into different categories. In some other embodiments with textual data, an embedding method such as word2vec may be applied to the textual data. Note that autoencoder is not the only method that can be used to embed the data. In other embodiments, a dimension reduction method such as Principal Component Analysis (PCA) may be used, or a neural network (NN) may be used by extracting the second to last layer.

In the illustrated embodiment, the embedding by the data-embedding sub-module 220 generates an output in the form of embedded data 230. The conversion to generate the embedded data 230 may be irreversible in some embodiments. For example, the embedded data 230 cannot be converted back into the original sensitive information 210 in its original format (e.g., SSNs in the form of strings in the example herein) by running the embedded data 230 through another function or algorithm. This is because after the embedded data 230 is created, the decoding piece of the model is discarded. For example, an autoencoder may have two parts: an encoder and a decoder. Both the encoder and the decoder are needed in training to ensure that the encoder encode information in a consistent manner (e.g., two similar inputs will have similar embeddings). However, after the training is complete, the decoder is discarded. As such, the embedded data 230 cannot be converted back to its original format in these embodiments.

The embedded data 230 is stored in an electronic database (e.g., the payment database 195 of FIG. 1). However, the embedded data 230 is inaccessible to the operator of the electronic database in which it is stored. The fact that the operator of the electronic database cannot directly access the embedded data 230 reduces the likelihood of a malicious actor being able to perpetrate a brute force type of attack on the embedded data 230 by posing as the database operator (e.g., via phishing, spoofing, or hacking into the access privileges of the database operator). In other words, even if the malicious actor is somehow able to gain access privileges afforded to the database operator through nefarious methods, the malicious actor still cannot reverse engineer the sensitive information 210 in its original form (e.g., the SSNs in this example), since the malicious actor is unable to directly access the embedded data 230 even with the database operator access privileges.

According to various aspects of the present disclosure, the data-embedding sub-module 220 is configured to convert the sensitive information 210 from a first format to the embedded data output in a second format as a part of the data embedding process. The second format may be different from the first format. For example, in the example shown in FIG. 2, the format of the sensitive information is a string, and the format of the embedded data 230 is a numeric vector. For example, the input string 123-45-6789 is converted into a 1×3 numeric vector (e.g., 1 row and 3 columns) of [0.5, 0.3, 0.6], the input string 234-56-7890 is converted into another 1×3 numeric vector of [0.2, 0.8, 0.9], and the input string 123-45-6789 is converted into yet another 1×3 numeric vector of [0.5, 0.3, 0.6]. Since a human being (even with the help of machines) is unable to recognize or uncover the input strings from the output numeric vectors, it may be said that the data embedding process obfuscates the sensitive information 210 (as the input) and makes the transformation of the sensitive information 210 irreversible.

After the embedded data 230 has been electronically stored in a suitable electronic database, requests to query the embedded data 230 may be received. In response to such requests, a noise-addition sub-module 240 of the data-embedding and noise-addition module 198 may add noise to the embedded data 230 corresponding to the query. In some embodiments, the noise-addition is performed using a noise function, such as a Batching function (e.g., a Batch Inference technique), though other types of noise addition techniques may be implemented in other embodiments. For example, an Application Programming Interface (API) call (in a given programming language, such as Python) may be used to retrieve a data entry and add noise to the data entry by generating a random number and modifying the data entry based on the random number.

In some embodiments, the following computer code may be utilized to perform at least a part of the noise addition:

```
SELECT
  emb_1 + RAND( ) * emb_noise_level AS encoded_emb_1
  , emb_2 + RAND( )* emb_noise_level AS encoded_emb_2
  , ...
  , emb_n + RAND( )* emb_noise_level AS encoded_emb_n
FROM ...
```

In the above example, the emb=[emb_1, . . . , emb_n] represents the embedding of the sensitive data to which noise should be added, and emb_noise_level represents the magnitude of the noise that should be added. The code above is example SQL code to add the noise in batch, where emb_1, . . . , emb_n are stored as n distinct columns.

Below is another simplified example of Python computer code that may be used to implement parts of the noise addition in real-time use cases:

def add_noise(emb, emb_noise_level, rng = np.random.default_rng( )):
return emb + rng.uniform(size=len(emb)) * emb_noise_level

It is also understood that the noise-addition need not necessarily be performed in response to receiving the query requests. For example, in some other embodiments, the noise-addition may be performed at a stage before the query requests are received. In some other embodiments, noise may also be added to the embedded data 230 before the embedded data 230 is stored in the electronic database. In yet other embodiments, the noise-addition may be performed in response to an explicit user request or in accordance to a guideline or policy (e.g., a General Data Protection Regulation (GDPR) guideline) to add noise. Furthermore, a different type or a different amount of noise may be added depending on the type of sensitive data 210. For example, some types of data (e.g., bank account information) may be deemed to be more sensitive than other types of data (e.g., an email address), and therefore a greater amount of noise (or a different type of noise) may be added to the types of data deemed more sensitive.

Regardless of how and/or when the noise is added, it is understood that the added noise further clouds the result of the query, as the noise addition may distort the values of the embedded data 230. In the illustrated embodiment, the noise-addition sub-module 240 outputs noise-added data 250, which may also include 1×3 numeric vectors, but whose numeric values are different than the numeric values of the embedded data 230. For example, the numeric vector of [0.5, 0.3, 0.6] of the embedded data is turned into a numeric vector of [0.4, 0.3. 0.5] via the noise addition, the numeric vector of [0.2, 0.8, 0.9] of the embedded data is turned into a numeric vector of [0.3, 0.7, 0.9] via the noise addition, and the numeric vector of [0.5, 0.3, 0.6] of the embedded data is turned into a numeric vector of [0.4, 0.3, 0.6] via the noise addition.

Note that one unique characteristic of the noise addition of the present disclosure is that a different noise (e.g., by type or amount) may be added for each query. For example, although two of the embedded data 230 have identical values-two of the vectors each have the values of [0.5, 0.3, 0.6]-their corresponding noise-added data are different: one of them is [0.4, 0.3, 0.5], while the other one is [0.4, 0.3, 0.6]. As such, the operator of the database (or any entity having access to the noise-added data 250) is unable to recognize that the two seemingly different outputs [0.4, 0.3, 0.5] and [0.4, 0.3, 0.6] actually came from identical input sources (e.g., the vector of [0.5, 0.3, 0.6], which were derived from the same SSNs 123-45-6789). As such, not only can the noise be added on an individual basis (e.g., at a signal level), the strength or amplitude of the noise added for each query can also be varied, which may be random as well. In this manner, the noise addition according to the present disclosure causes further impediments to malicious actors attempting to hack into the sensitive information 210 in its original form. In other embodiments, the strength of the noise added may be fixed, so that the output is more usable by machine learning models and/or by analytics.

Furthermore, since unauthorized access to the original sensitive information 210 is made more difficult, the present disclosure may facilitate the sharing of the sensitive information between various entities. For example, the merchant entity that generated or collected the original sensitive information 210 may be more willing to share the sensitive information with the payment provider that operates the payment provider server 170 (see FIG. 1), since the payment provider cannot gain access to the original sensitive information 210, thereby reducing the risks of data leaks or hacks.

Meanwhile, although the noise-added data 250 can effectively conceal their corresponding underlying sensitive information 210, the noise-added data 250 may still be useful in a data modeling and/or analytics context, particularly since the format of the noise-added data 250 is in the numeric vector format, which is well suited for machine learning. In that regard, although a single instance of the noise-added data 250 may not be particularly useful, when a large amount of noise-added data 250 is obtained, it may be used to perform a machine process to extract valuable insight on the general trends or overall characteristics of the sensitive information 210. For example, the machine learning process may reveal a shopping trend for a particular product and/or service, an age range age and/or a gender of the users for purchasing a particular product or service, a geographical cluster of the users in being victims of fraud or other malicious attacks, etc.

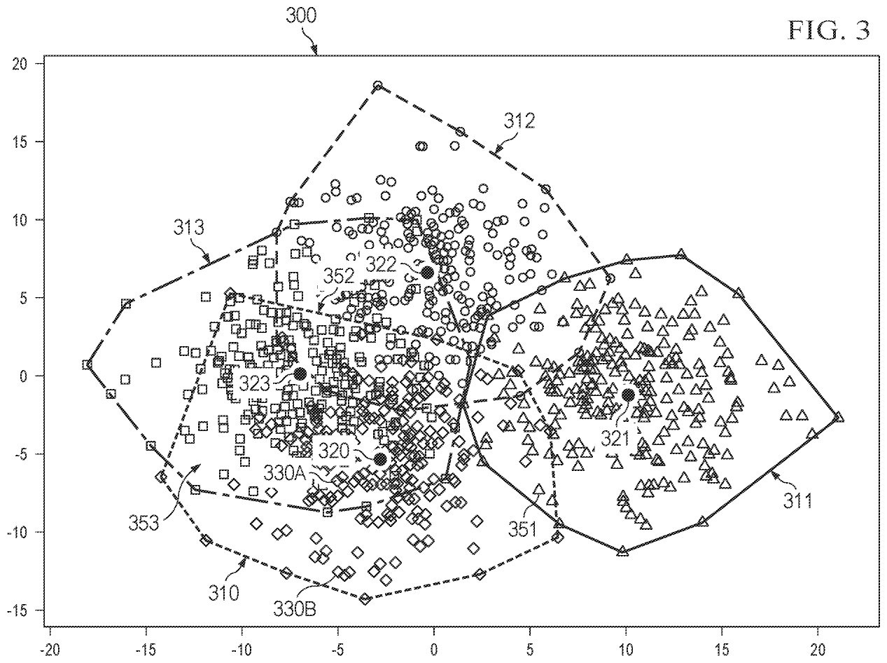

The noise added can also be flexibly tuned to achieve a desired balance between data protection and analytical model usability or performance. For example, FIG. 3 is a graph 300 that illustrates a visual representation of the impact of noise tuning according to a simplified example of the present disclosure. In more detail, the graph 300 illustrates four example clusters 310, 311, 312, and 313. Each of the clusters may have a respective centroid, such as a centroid 320 for the cluster 310, a centroid 321 for the cluster 311, a centroid 322 for the cluster 312, and a centroid 323 for the cluster 313. Each of the centroids 320-323 represents the “true” value (e.g., without noise added to it) of the respective embedded sensitive data stored in the database, and each of the clusters 310-313 surrounding the respective centroids 320-323 represents the noise-added values of the embedded sensitive data corresponding to different queries.

For example, suppose that the centroid 320 represents the embedded sensitive data in the form of a 1×3 vector of [0.5, 0.3, 0.6] discussed above with reference to FIG. 2, which itself is an embedded (e.g., obfuscated) version of the sensitive data (e.g., an SSN) whose original form is a string of 123-45-6789. Each of the dots in the cluster 310 that surrounds the centroid 320 corresponds to a noise-added version of the embedded sensitive data in response to a query. For example, a dot 330A in the cluster 310 may represent a first instance of the noise-added data in the form of a 1×3 vector of [0.4, 0.3, 0.6], and a dot 330B in the cluster 310 may represent a second instance of the noise-added data in the form of a 1×3 vector of [0.4, 0.3, 0.5].

As shown visually in FIG. 3, the dot 330B is located farther from the centroid 320 than the dot 330A, which reflects the fact that a greater amount of noise is added to the data corresponding to the dot 330B than to the data corresponding to the dot 330A. In other words, the vector of [0.4, 0.3, 0.5] (i.e., the noise-added data corresponding to the dot 330B) differs from the vector of [0.5, 0.3, 0.6] more than the vector of [0.4, 0.3, 0.6] (i.e., the noise-added data corresponding to the dot 330A), which is due to a greater amount of noise being used to generate the vector of [0.4, 0.3, 0.5] from the vector of [0.5, 0.3, 0.6]. Specifically, in this non-limiting example, the noise added to the centroid 320 to generate the dot 330A corresponds to a subtraction of 0.1 from the first column of the vector of [0.5, 0.3, 0.6] (which results in the vector of [0.4, 0.3, 0.6]), whereas the noise added to the centroid to generate the dot 330B corresponds to a subtraction of 0.1 from the first column of the vector of [0.5, 0.3, 0.6], as well as a subtraction of 0.1 from the third column of the vector of [0.5, 0.3, 0.6]. (which results in the vector of [0.4, 0.3, 0.5]). This greater amount of noise is reflected visually in the graph 300 by the greater distance between the dot 330B and the centroid 320 (compared to the distance between the dot 330A and the centroid 320). As discussed above, the noise may be added for each query on an individual basis, and the strength of the noise added for each query can also be varied in a random manner.

In any case, the numerous other dots of the cluster 310 each correspond to a different instance of the noise-added data generated in response to a different query. In some embodiments, the noise used to generate the dots may be random but within a predefined range. As a result, the density of the dots within the cluster 310 is greater near the centroid 320 but decreases the farther away it gets from the centroid 320. The noise-added data corresponding to these dots are accessible by an operator of the database within which the data corresponding to the centroid 320 is stored (e.g., the target of the query). However, since noise is already introduced to generate these dots, the database operator (or a malicious actor that somehow gained access privileges of the database operator) cannot reverse engineer the data (e.g., the vector of [0.5, 0.3, 0.6]) corresponding to the centroid 320, much less the sensitive data in the original form (e.g., the SSN in the string form of 123-45-6789) from which the data corresponding to the centroid was derived. As such, data security is enhanced. Note that although the above discussions are facilitated using the cluster 310 and the dots therein as a non-limiting example, similar concepts apply to the other clusters 311-313 as well.

Data security is further enhanced by the overlapping coverage among the clusters 310-313. As non-limiting examples, an overlap region 351 exists between the clusters 310 and 311, an overlap region 351 exists between the clusters 310 and 312, and an overlap region 352 exists between the clusters 310 and 312. If a dot is located within one of these overlap regions 351-353, it means that it could have been generated based on either of the centroids of the two corresponding clusters that created the overlap region. As such, even when an entity has access to the noise-added data associated with the overlap regions 351-353, such an entity will not be able to determine from which of the clusters 310-313 the noise-added data in the overlap region came. Therefore, it is even more difficult for a malicious actor to reverse engineer the original sensitive data (based on which the clusters 310-313 are generated). In this manner, the creation of overlap regions according to the present disclosure further improves data security and the protection of sensitive information.

It is understood that the sizes of the overlap regions 351-353 are dictated by the amount of noise used to generate the clusters 310-313. The greater the amount of noise used, the larger the sizes of the overlap regions 351-353, and vice versa. While larger overlap regions 351-353 create more difficulties for malicious actors to reverse engineer the original sensitive information (e.g., since more and more noise-added data located in the overlap regions could have come from multiple clusters), excessively large overlap regions 351-353 may have potential downsides as well. For example, an entity may wish to use the noise-added data to build and/or train models (e.g., machine learning models) as a part of data analytics to extract valuable insight from the sensitive information. As the overlap regions 351-353 become larger, the performance of these models may degrade. For example, the models may become less accurate in their predictions, and/or may take longer to run, as discussed in more detail below.

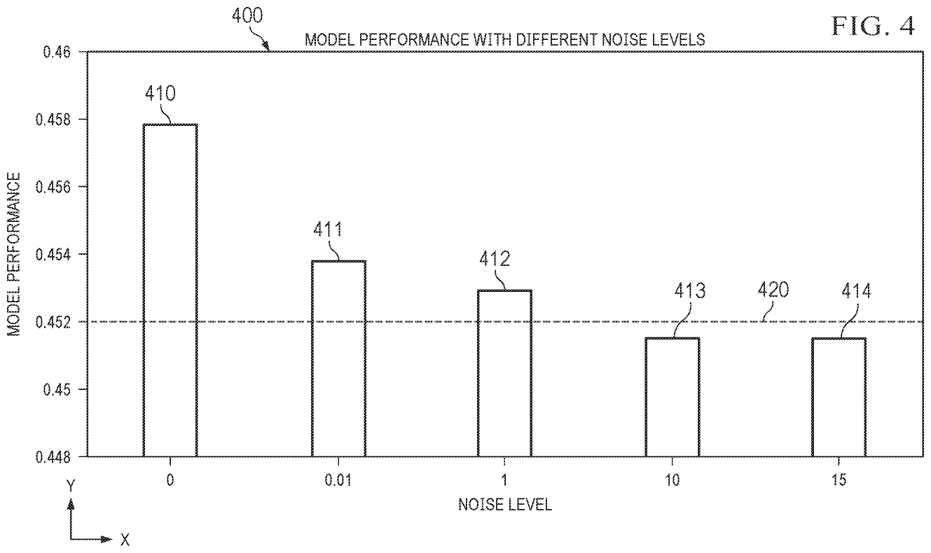

FIGS. 4-7 illustrate various examples of the relationship between noise level and model performance according to embodiments of the present disclosure. Referring to FIG. 4, a graph 400 is illustrated, which represents the relationship between model performance versus noise level for data corresponding to a sensitive attribute of “customer intent”. The graph 400 includes an X-axis and a Y-axis. The X-axis corresponds to a noise level, for example, an amount of noise added by the noise-addition sub-module 240 to generate the noise-added data 250 (see FIG. 1). The Y-axis corresponds to a model performance, for example, a prediction of a binary classification model to predict a user's Net Promoter Score (NPS), where 1=detractor, and 0=[promoter, passive]. In some embodiments, the binary classification model may be trained using a machine learning model based on a sufficiently large amount of noise-added data similar to the noise-added data 250 of FIG. 1.

The graph 400 also illustrates a plurality of vertical bars, such as vertical bars 410, 411, 412, 413, and 414. Each of the vertical bars 410-414 represents the model performance for a specific amount of noise level (e.g., a specific amount of noise added to generate the noise-added data 250 of FIG. 1). According to the simplified example of FIG. 4, the vertical bar 410 (at a noise level of 0) has a greater performance (e.g., more accurate and/or faster predictions) than the vertical bar 411 (at a noise level of 0.01), which has a greater performance than the vertical bar 412 (at a noise level of 1), which has a greater performance than the vertical bar 413 (at a noise level of 10), which has a greater performance than the vertical bar 414 (at a noise level of 15). Note that the numeric values of the noise levels in this simplified example may or may not represent the actual amount (e.g., a specific noise value) of noise added to generate the noise-added data, though FIG. 4 does illustrate the trend that as the noise level increases, the model performance worsens.

FIG. 4 also illustrates a baseline 420 that manifests as a horizontal line. The baseline 420 represents a baseline model performance when the sensitive attribute (e.g., “customer intent”) of the sensitive information 210 of FIG. 1 is not used. It may be desirable to select a noise level that is at least above the baseline 420, because otherwise it could mean that the model performance has been unduly degraded with the addition of what may be an excessive amount of noise to generate the noise-added data. In this example, the vertical bars 410, 411, and 412 each have a performance that is better than the baseline 420, which makes their corresponding noise levels of 0, 0.01, and 1 suitable candidates.

However, as discussed above with reference to FIG. 3, increasing the amount of noise used will increase the sizes of the overlap regions, which will lead to more robust data security. Therefore, a tradeoff needs to be made between model performance and data security. Different entities may evaluate such a tradeoff differently based on their needs. For example, a first entity that places a greater emphasis on model performance (as opposed to data security) may choose the noise level corresponding to the vertical bar 410, since that yields the best model performance while still offering some degree of data security via the addition of noise. On the other hand, a second entity that places a greater emphasis on data security (as opposed to model performance) may choose the noise level corresponding to the vertical bar 412, since that yields the best data security while still offering a better-than-baseline model performance.

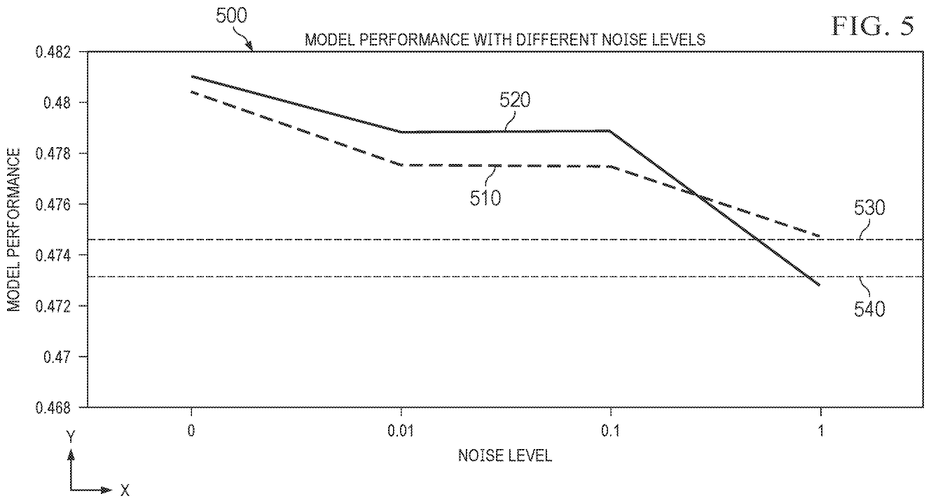

FIG. 5 illustrates another example of a relationship between noise level and model performance via a graph 500. The graph 500 also includes an X-axis and a Y-axis, where the X-axis corresponds to a noise level (e.g., an amount of noise added by the noise-addition sub-module 240 to generate the noise-added data 250), and the Y-axis corresponds to a model performance (e.g., a prediction of a binary classification model to predict a user's NPS). Similar to FIG. 4, the binary classification model may be trained using a machine learning model based on a sufficiently large amount of noise-added data similar to the noise-added data 250 of FIG. 1.

Whereas the relationship between model performance and noise level is illustrated via the plurality of vertical bars 410-414 in FIG. 4, such a relationship is illustrated in FIG. 5 via two plots: a plot 510 and a plot 520. The plot 510 corresponds to the data associated with a sensitive attribute of “country” (e.g., the country within which a user is located), and the plot 520 corresponds to the data associated with a sensitive attribute of “age band” (e.g., the age range within which a user falls). Based on the behavior of the plots 510 and 510 in FIG. 5, it can be seen that the model performance generally drops as the amount of noise added increases. Again, it is understood that the numeric values of the noise levels in the simplified example of FIG. 5 may or may not represent the actual amount (e.g., a specific noise value) of noise added to generate the noise-added data.

FIG. 5 also illustrates a baseline 530 and a baseline 540 that each manifest as a horizontal line. The baseline 530 represents a baseline model performance when the sensitive attribute (e.g., “country”) associated with the plot 510 is not used, and the baseline 540 represents a baseline model performance when the sensitive attribute (e.g., “age band”) associated with the plot 520 is not used. As such, it may be desirable to select noise levels for the plots 510 and 520 that are at least above their respective baselines 530 and 540, because otherwise it could mean that the model performance has been unduly degraded with the addition of what may be an excessive amount of noise to generate the noise-added data.

In the example of FIG. 5, it can be seen that for both the plot 510 and the plot 520, the model performance is at or near a peak level when the noise level is close to 0. The model performance begins to drop as the noise level increases toward about 0.01. When the noise level increases from about 0.01 to about 0.1, the model performance remains mostly steady and is still relative good (though not at a peak level). After the noise level increases beyond about 0.1, however, the model performance may deteriorate rapidly. At a noise level of about 1, the model performance for both the plot 510 and the plot 520 may dip below their respective baselines 530 and 540, respectively.

As discussed above, increasing the amount of noise used will increase the sizes of the overlap regions, which will lead to more robust data security at the cost of model performance. Based on the plot behavior illustrated in FIG. 5, it may be beneficial to select a noise level of about 0.1 (e.g., the amount of noise used to generate the noise-added data 250 of FIG. 1). This is because the model performance for both the plot 510 (e.g., representing the sensitive attribute of “country”) and the plot 520 (e.g., representing the sensitive attribute of “age band”) is relatively good (e.g., above their respective baselines 530 and 540), while a sufficient amount of noise is still used, which provides data security.

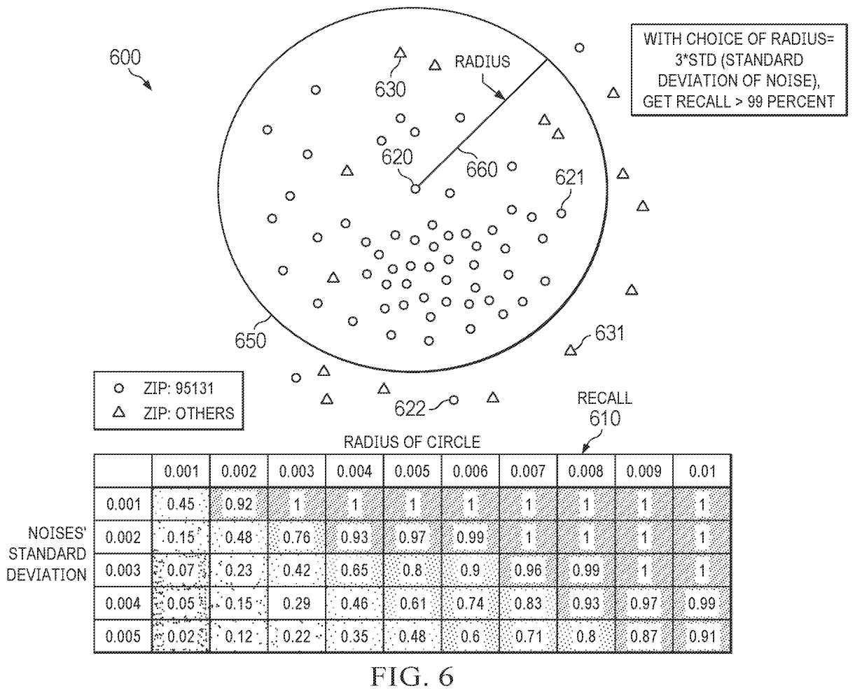

FIG. 6 illustrates a graph 600 and a table 610 (also listed below as Table 1) that help demonstrate the concept of noise recall coverage. In more detail, the graph 600 illustrates a plurality of dots, such as dots 620, 621, and 622, as well as a plurality of triangles, such as triangles 630 and 631. The dots 620-622 each represent a query result of a sensitive attribute, such as “merchant total payment volume” (TPV) in this example. As discussed above, a different amount of noise may be added to generate the query results for each new query. As such, a plurality of different dots may be generated based on a centroid dot 620, where the other dots (e.g., dots 621-622) are generated to be scattered around the centroid dot 620, depending on the amount of noise added for each particular query.

In the simplified example of FIG. 6, the dots and the triangles correspond to sensitive attributes from different zip codes. For example, the dots (e.g., the dots 620-622) represent the merchant TPV corresponding to an example zip code of 95131, and the triangles (e.g., the triangles 630-631) represent the merchant corresponding to zip codes other than the zip code of 95131. It is understood that in a real-world scenario, a much greater number of dots and triangles may be generated than what is shown in the simplified example of graph 600. For example, thousands or even tens of thousands of dots and triangles—each corresponding to a different database query result with a certain amount of noise added—may be generated. Such a large number facilitates the performance of a Monte-Carlo analysis or a Bayesian analysis, which may be used to conduct data analytics.

The graph 600 includes a circle 650. The circle 650 represents a boundary used to estimate a recall coverage. In more detail, as shown in the graph 600, a subset of the dots (e.g., the dots 620-621) are located inside the circle 650, while another subset of the dots (e.g., the dot 622) are located outside the circle 650. Similarly, a subset of the triangles (e.g., the triangle 630) are located inside the circle 650, while another subset of the dots (e.g., the triangle 631) are located outside the circle 650. In this regard, the region covered by the circle 650 may be conceptually similar to one of the clusters 310-313 of FIG. 3, in the sense that it visually represents a region corresponding to the noise-added data scattered around a centroid datapoint (e.g., the dot 620 in FIG. 6) based on which the noise-added data are generated. In addition, the regions within the circle 650 that also contain the triangles (e.g., the triangle 630) may be conceptually similar to one of the overlap regions 351-353 of FIG. 3, since the triangles correspond to the noise added data of merchant TPVs of different zip codes that “bled into” the zip code 95131 (e.g., the region covered by the circle 650).

It can be seen that the size of the circle 650 (dictated by a length of a radius 660) may determine how many (e.g., a percentage) of the dots fall within the circle 650. In other words, as the radius 660 increases, the circle 650 becomes larger, which means that a greater number (and/or percentage) of the dots will be covered by the circle 650. Conversely, as the radius 660 decreases, the circle 650 becomes smaller, which means that a smaller number (and/or percentage) of the dots will be covered by the circle 650. The percentage of the dots covered by the circle 650 may be referred to as a recall coverage. Table 610 of FIG. 6 (whose values are reproduced below in Table 1) illustrates various example scenarios of the recall coverage.

TABLE 1
(Recall Coverage)

| | | Radius of circle | | | | | | | | | |
|---|---|---|---|---|---|---|---|---|---|---|---|
| | | 0.001 | 0.002 | 0.003 | 0.004 | 0.005 | 0.006 | 0.007 | 0.008 | 0.009 | 0.01 |
| Standard | 0.001 | 0.45 | 0.92 | 1 | 1 | 1 | 1 | 1 | 1 | 1 | 1 |
| deviation | 0.002 | 0.15 | 0.48 | 0.76 | 0.93 | 0.97 | 0.99 | 1 | 1 | 1 | 1 |
| of Noise | 0.003 | 0.07 | 0.23 | 0.42 | 0.65 | 0.8 | 0.9 | 0.96 | 0.99 | 1 | 1 |
| | 0.004 | 0.05 | 0.15 | 0.29 | 0.46 | 0.61 | 0.74 | 0.83 | 0.93 | 0.97 | 0.99 |
| | 0.005 | 0.02 | 0.12 | 0.22 | 0.35 | 0.48 | 0.6 | 0.71 | 0.8 | 0.87 | 0.91 |

In more detail, the table 610 of FIG. 6 (and Table 1 above) includes a plurality of rows and a plurality of columns. The rows correspond to different standard of deviations of noise used to generate the graph 600 (or graphs similar to the graph 600), whereas the columns correspond to different radii of the circle (e.g., the radius 660 of the circle 650) used to determine the recall coverage. When the standard deviation of noise is small (meaning that generally small amounts of noise are added), the dots of the graph 600 will be scattered more closely around the centroid 620. Consequently, a smaller circle 650 (corresponding to a smaller radius 660) is sufficient to cover most of the dots generated around the centroid 620.

For example, suppose that a minimum of 99% of recall coverage is desired. As indicated by the table 610 of FIG. 6 (and Table 1 above), when the standard deviation of noise is 0.001, just a radius of 0.003 is needed to produce a recall coverage of 100% (e.g., a value of 1 shown in the table). As the standard deviation of noise increases from 0.001 to 0.002, a larger radius of 0.006 may be needed to produce a recall coverage of 99% (e.g., a value of 0.99 shown in the table). As the standard deviation of noise increases from 0.002 to 0.003, a radius of 0.008 may be needed to produce a recall coverage of 99% (e.g., a value of 0.99 shown in the table). As the standard deviation of noise increases from 0.003 to 0.004, a larger radius of 0.01 may be needed to produce a recall coverage of 99% (e.g., a value of 0.99 shown in the table). As the standard deviation of noise increases from 0.004 to 0.005, the maximum radius of 0.01 shown in the table herein may only produce a recall coverage of 91% (e.g., a value of 0.91 shown in the table), which indicates that a radius larger than 0.01 is needed to produce a recall coverage of 99% or better.

Nevertheless, based on the data values of the Table 610 of FIG. 6, it may be readily apparent that when a radius is at three times the standard deviation of noise, the recall coverage can meet or exceed 99%, which is a satisfactory recall coverage (although other thresholds may be considered satisfactory for different systems and uses). Therefore, for the particular sensitive attribute (e.g., “zip code”) in the example of FIG. 6, the radius can be set to three times the standard deviation of noise to ensure a satisfactory recall coverage. It is understood that the radius may be set to a different value for other sensitive attributes (e.g., “country”, “age band”, etc.), based on an analysis performed to those sensitive attributes in a manner similar to what was described above with reference to FIG. 6.

Based on the above, it can be seen that instead of getting a zip code (as an example sensitive attribute) for a merchant, a data embedding plus noise can be obtained fro each merchant. When the embedding is plotted out in a two-dimensional manner, a graph similar to the graph 600 may be obtained. To get the merchant TPV within a zip code, a circle can be created, and the TPV of each merchant is summed to obtain the total TPV for the zip code. In other words, using zip code as an example sensitive attribute, the merchant TPV is calculated in the zip code. This process showcases the analytical capability of the method of the present disclosure.

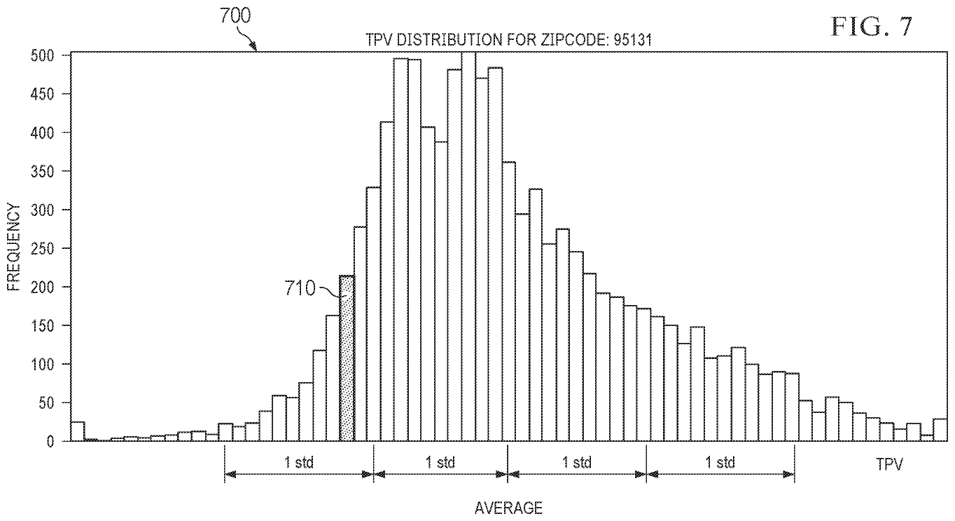

FIG. 7 illustrates a histogram 700 that associated with an analytical use case of the noise addition according to various aspects of the present disclosure. The histogram 700 includes an X-axis and a Y-axis. The X-axis corresponds to different TPVs, and the Y-axis corresponds to a frequency of occurrence for each value (or a value range) of TPVs. The histogram 700 includes a plurality of vertical bars, such as a vertical bar 710. The location of each of the vertical bars on the X-axis represents a different noise-added TPV of merchants within a given zip code, such as the zip code of 95131 in this example. The magnitude of each of the vertical bars on the Y-axis represents the number of occurrences (e.g., 25 occurrences of a TPV of $1000, 120 occurrences of a TPV of $10000, and 200 occurrences of a TPV of $100000, etc.) of that vertical bar.

The vertical bars are generated by adding noise to an original (e.g., actual) TPV, which corresponds to the vertical bar 710 in FIG. 7 in this simplified example. To demonstrate, suppose that the original TPV is $3721.5. Some example noise-added TPVs derived from the original TPV may be: $3732.43, $3642.62, $3788.72, and $3789.06. Of course, thousands more of the noise-added TPVs may be generated in a real-world scenario. In any case, the exact value of the noise-added TPV may be different each time (e.g., in response to each database query of the original TPV), based on the exact type of noise-addition technique used and/or the amount of noise added each time. However, the noise-added TPVs are generated in a manner such that they do not deviate from the value of the original TPV too greatly. As shown in the histogram 700, the actual TPV (represented by the vertical bar 710) falls within two standard deviations (std) of an average value of the noise-added TPV. It can also be seen that within two standard deviations of the average value of the noise-added TPV. a majority of the occurrences of the noise-added TPVs are covered. Accordingly, the generation of the noise-added TPV represented by the histogram 700 herein may be considered a successful generation, and the histogram 700 may be used hereinafter to perform various data analytics, such as extracting valuable insight with respect to certain trends associated with merchant TPVs in various zip codes.

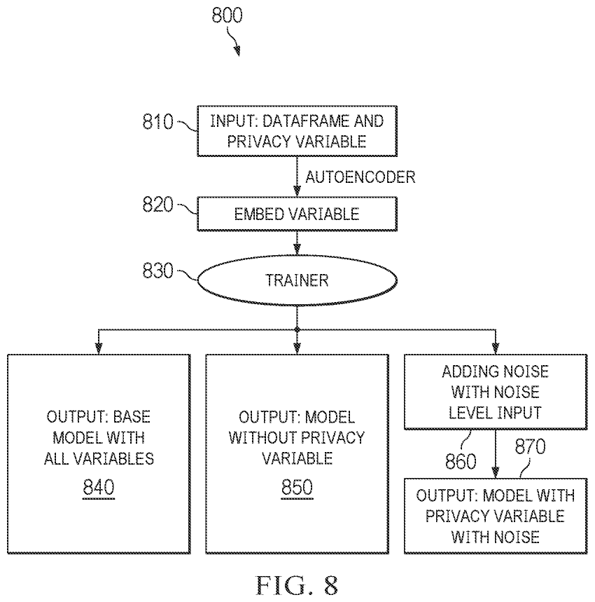

FIG. 8 illustrates an example modeling automation pipeline 800 according to an embodiment of the present disclosure. The modeling automation pipeline 800 includes an input 810. In the illustrated embodiment, the input is in the structure of a data-frame, which may be organized as a multi-dimensional structure. For example, the input data may be organized as a table containing rows and columns, which may allow the input data to be easily used in spreadsheets and/or other data analytics/processing tools. The data of the input 810 may include various types of sensitive information discussed above. For example, the sensitive information may include a privacy variable, such as a user's age, address, phone number, or other suitable types of sensitive information 210 of FIG. 2.

The modeling automation pipeline 800 includes a module 820 that embeds the input 810 (e.g., the privacy variable). In some embodiments, the module 820 may be similar to the data-embedding sub-module 220 of FIG. 2. For example, the module 820 may utilize an autoencoder to convert the data of the input 810 from one format to another format (e.g., from a string format to a numeric-vector format). In some embodiments, the conversion of the data may be irreversible. For example, the converted output data cannot be converted back to the input data merely by applying a function or an algorithm to the converted output data. The converted data is embedded (e.g., electronically stored) in an electronic database. However, to ensure data security, an operator of the electronic database may not have direct access to the embedded data in some embodiments. The lack of direct access to the embedded data means that it would be difficult for a malicious actor (who has unlawfully gained access to the database) to successfully conduct a brute-force type of attack on the embedded data in an effort to reverse engineer the data of the input 810, since there is no data on which to reverse engineer in the first place.

The modeling automation pipeline 800 includes a trainer 830 that trains the embedded data. For example, the trainer 830 may include a machine learning trainer. The machine learning trainer may use the embedded data as training data to train a machine learning model. In various embodiments, the machine learning model may include, but are not limited to: artificial neural networks, binary classification, multiclass classification, regression, random forest, reinforcement learning, deep learning, cluster analysis, supervised learning, decision trees, etc.

The modeling automation pipeline 800 may generate an output 840 based on the trainer 830. In this case, the machine learning model of the trainer 830 may be trained as a base model with all of the variables, including all of the sensitive information (e.g., the privacy variables). In this manner, the output 840 may be considered a baseline output for evaluating the performance of models. In some embodiments, the output 840 may be in the form of a prediction.

The modeling automation pipeline 800 may also generate an output 850 based on the trainer 830. Unlike the output 840, the output 850 is generated by training the machine learning model of the trainer 830 without the privacy variable that was embedded by the module 820. As such, the output 850 (which may also be in the form of a prediction in some embodiments) may be compared against the output 840 to gauge how much impact removing the privacy variable may have on the overall model performance.

The modeling automation pipeline 800 may also add noise via a module 860 to generate another output 870. In some embodiment, the module 860 may be similar to the noise-addition sub-module 240 of FIG. 2. The module 860 may add noise to the embedded variables to generate noise-added data similar to the noise-added data 250 of FIG. 2. In some embodiments, the noise may be added via a Batch Inference technique, or another suitable technique. In some embodiments, the noise may be added to the embedded variables before the trainer 830 is used to train a machine learning model based on the noise-added data.

In any case, the output 870 may also be compared against the output 840 and/or against the output 850 to evaluate the different model performances corresponding to the different scenarios (e.g., baseline model with all variables, model without the privacy variables, and the model with privacy variables having noise added thereto). In this manner, the type and/or amount of noise added can be quickly tuned based on the comparison results. For example, if the comparison results between the outputs 840, 850, and 870 indicate that the model performance has suffered beyond a predefined threshold, then the noise level set by the module 860 may be reduced to improve the model performance. On the other hand, if the comparison results between the outputs 840, 850, and 870 indicate that the model performance has not degraded much even as the noise level is raised, then the module 860 may continue to increase the noise level in an effort to improve data security.

In an embodiment, the following computer programming code (e.g., in the Python language) may be used to implement various portions of the modeling automation pipeline 800:

```
import pandas as pd
from privacy_embedding.privacy_embedding.PETrainer
import PETrainer
import pickle
data = pd.read_csv(data_path)
var_list = pickle.load(open(var_list_path, ‘rb’))
cat_list = pickle.load(open(cat_list_path, ‘rb’))
ebd_var = ‘r_gcp_c360_consu_age_band_15d’
y_col = ‘label’
trainer = PETrainer(data, var_list, cat_list, ebd_var, y_col)
trainer.encoding(dim = 2)
base_pred = trainer.Train_base(path = path + ‘pred_age_base’
  , name = ‘pred_age_base’)
no_age_pred = trainer.Train_no_ebd(path =
path + ‘pred_age_no_ebd’
    , name = ‘pred_age_no_ebd’)
age_noise_1p_pred = trainer.Train_ebd_noise(path =
path + ‘pred_age_n1p’
      ,name = ‘pred_age_n1p_ebd’
      , noise_level = 0.01)
age_noise_10p_pred = trainer.Train_ebd_noise(path =
path + ‘pred_age_n10p’
      ,name = ‘pred_age_n10p_ebd’
      , noise_level = 0.1)
results = trainer.pred_df
```

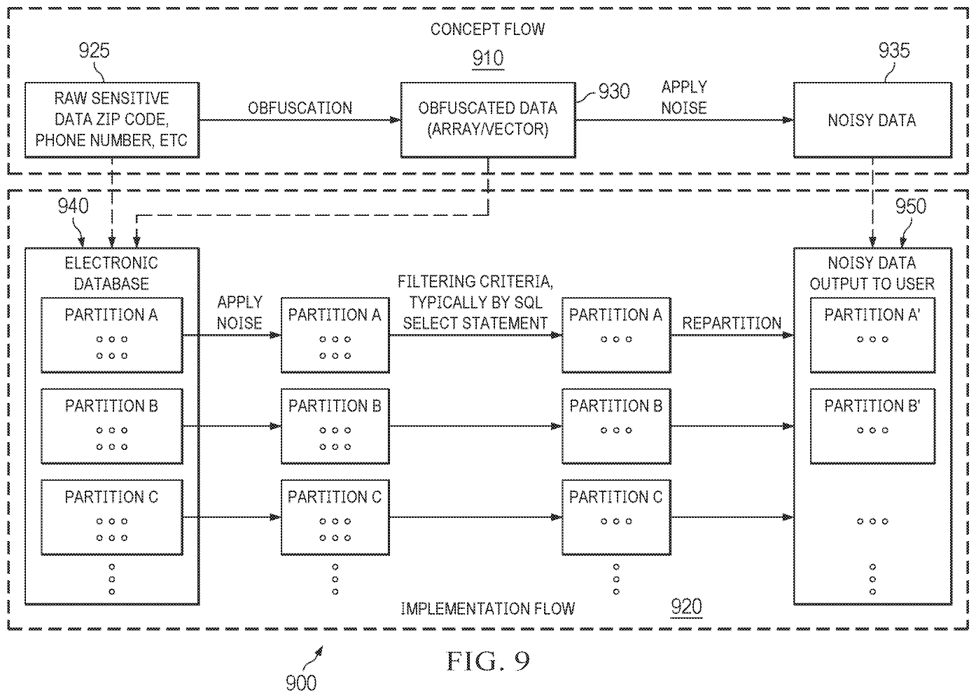

FIG. 9 illustrates a flow 900 comprising a higher-level concept flow 910 and a lower-level implementation flow 920 of various aspects of the present disclosure. The concept flow 910 begins with a step 925, in which raw sensitive data is accessed. The raw sensitive data may include zip code, phone number, or other types of sensitive information 210 discussed above with reference to FIG. 2. The raw sensitive data may be in a non-numeric-vector format, for example, in a string format or an alphanumeric format.

The concept flow 910 includes a step 930, in which the raw sensitive data accessed in step 925 is obfuscated. In some embodiments, the obfuscation of the raw sensitive data may include converting the raw sensitive data in its original raw format into a numeric-vector format or in an array format. The obfuscation may be performed in a manner such that the converted data (e.g., in the numeric-vector format or in the array format) cannot be readily converted back to the original raw format merely by running the converted data through any function or converter. In some embodiments, the step 930 may be performed using a module similar to the data-embedding sub-module 220 discussed above with reference to FIG. 2. As such, the output generated by the step 930 may be similar to the embedded data 230 discussed above with reference to FIG. 2. In some embodiments, the output generated by the step 930 is stored in an electronic base but is not directly accessible to a user or an operator of the electronic database, which prevents malicious actors from using such an output to reverse engineer the raw sensitive data via brute-force type of techniques.

The concept flow 910 includes a step 935, in which noisy data is generated by adding noise to the obfuscated data outputted by step 930. In some embodiments, the noise may be added using a Batching technique (e.g., Batch Inference) or another suitable technique. In some embodiments, the noise addition may be performed via a module similar to the noise-addition sub-module 240 discussed above with reference to FIG. 2. As such, the noisy data output generated by the step 935 may be similar to the noise-added data 250 discussed above with reference to FIG. 2. The noisy data output generated by the step 935 is available to the user or operator of the electronic database on which the obfuscated data is stored. As such, the noisy data output generated by the step 935 may still be used in data analytics, for example via machine learning models.

The implementation flow 920 may be a concrete real-world example of how the concept flow 910 may be implemented. In the embodiment illustrated in FIG. 9, the implementation flow 920 is performed in the context of a distributed electronic storage environment, for example, in accordance with a MapReduce framework. In more detail, the steps 925 and the steps 930 may be performed to embed data into an electronic database 940. In some embodiments, the electronic database 940 is compatible with a SPARK Structured Query Language (SQL) database, as well as with Parquet files. In some embodiments, the electronic database 940 includes a plurality of partitions, such as a partition A, a partition B, and a partition C, etc. In some embodiments, the obfuscated data outputted by the step 930 of the concept flow 910 may be embedded in any one of the partitions A-C. In some embodiments, the original raw sensitive data may also be electronically stored in one of the partitions A-C. In some embodiments, the obfuscated data outputted by the step 930 and the original raw sensitive data may be stored in different partitions A-C. For example, the obfuscated data outputted by the step 930 may be stored in the partition A, while the original raw sensitive data may be stored in the partition C, or vice versa.

Following the embedding of the obfuscated data, the implementation flow 920 may apply noise to the embedded data in response to database queries for the embedded data. The embedded data, after being applied with the noise, may still be stored in their respective partitions A-C. In some embodiments, one or more filtering criteria may be applied to the data stored in the partitions A-C. For example, the filtering criteria may include SQL select statements. Thereafter, the data is repartitioned when noisy data 950 (corresponding to the noisy data generated by step 935 of the concept flow 910) is outputted for a user/operator of the electronic database 940. For example, instead of the original partitions A-C, the new partitions may include a partition A′, a partition B′, etc. Each of the new partitions A′-B′ may include data from multiple ones of the original partitions A-C. According to various aspects of the present disclosure, the user/operator of the electronic database 940, or an entity generating the database queries, may have access to the noisy data 950, but not the original raw sensitive data or the embedded obfuscated data (from which the noisy data 950 is generated). In this manner, the present disclosure reduces the likelihood of the leakage of sensitive information and therefore improves electronic data security. Other benefits may include compatibility and easy integration with well-known distributed storage schemes.

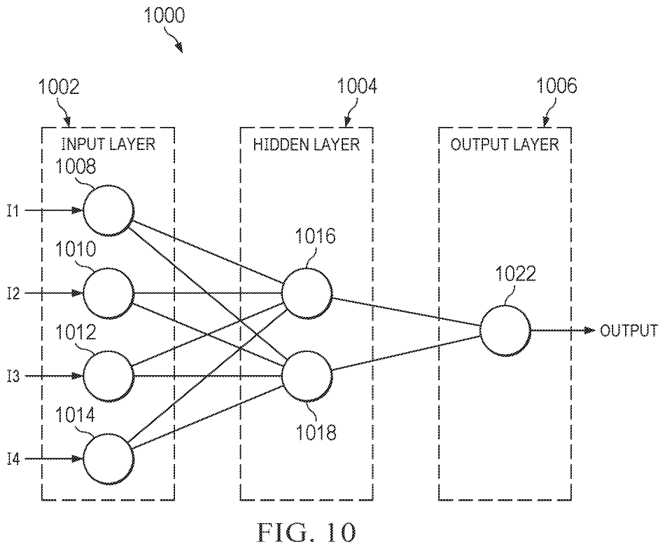

In some embodiments, the machine learning processes of the present disclosure may be performed at least in part via an artificial neural network, an example block diagram of which is illustrated in FIG. 10. As shown in FIG. 10, the artificial neural network 1000 includes three layers-an input layer 1002, a hidden layer 1004, and an output layer 1006. Each of the layers 1002, 1004, and 1006 may include one or more nodes. For example, the input layer 1002 includes nodes 1008-1014, the hidden layer 1004 includes nodes 1016-1018, and the output layer 1006 includes a node 1022. In this example, each node in a layer is connected to every node in an adjacent layer. For example, the node 1008 in the input layer 1002 is connected to both of the nodes 1016-1018 in the hidden layer 1004. Similarly, the node 1016 in the hidden layer is connected to all of the nodes 1008-1014 in the input layer 1002 and the node 1022 in the output layer 1006. Although only one hidden layer is shown for the artificial neural network 1000, it has been contemplated that the artificial neural network 1000 used to implement machine learning modules and may include as many hidden layers as necessary. In this example, the artificial neural network 1000 receives a set of input values and produces an output value. Each node in the input layer 1002 may correspond to a distinct input value.

In some embodiments, each of the nodes 1016-1018 in the hidden layer 1004 generates a representation, which may include a mathematical computation (or algorithm) that produces a value based on the input values received from the nodes 1008-1014. The mathematical computation may include assigning different weights to each of the data values received from the nodes 1008-1014. The nodes 1016 and 1018 may include different algorithms and/or different weights assigned to the data variables from the nodes 1008-1014 such that each of the nodes 1016-1018 may produce a different value based on the same input values received from the nodes 1008-1014. In some embodiments, the weights that are initially assigned to the features (e.g., input values) for each of the nodes 1016-1018 may be randomly generated (e.g., using a computer randomizer). The values generated by the nodes 1016 and 1018 may be used by the node 1022 in the output layer 1006 to produce an output value for the artificial neural network 1000. When the artificial neural network 1000 is used to implement machine learning, the output value produced by the artificial neural network 1000 may indicate a likelihood of an event.

The artificial neural network 1000 may be trained by using training data. For example, the training data herein may include the noise-added data 250 of FIG. 2, or the noisy data 950 of FIG. 9. By providing training data to the artificial neural network 1000, the nodes 1016-1018 in the hidden layer 1004 may be trained (e.g., adjusted) such that an optimal output is produced in the output layer 1006 based on the training data. By continuously providing different sets of training data and penalizing the artificial neural network 1000 when the output of the artificial neural network 1000 is incorrect, the artificial neural network 1000 (and specifically, the representations of the nodes in the hidden layer 1004) may be trained to improve its performance in data classification. Adjusting the artificial neural network 1000 may include adjusting the weights associated with each node in the hidden layer 1004.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm-which may be a non-probabilistic binary linear classifier-may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

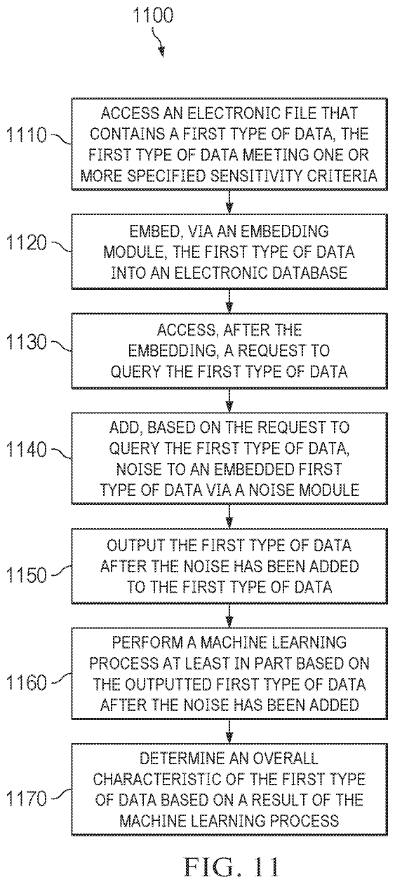

FIG. 11 is a flowchart illustrating a method 1100 of enhancing data security according to various aspects of the present disclosure. The method 1100 may be performed by a system that includes a processor and a non-transitory computer-readable medium associated with or managed by any of the entities or systems described herein. The computer-readable medium has instructions stored thereon, where the instructions are executable by the processor to cause the system to perform the various steps of the method 1100.

The method 1100 includes a step 1110 to access an electronic file that contains data of a first type. The data of the first type meets one or more specified sensitivity criteria. In some embodiments, the data of the first type may include a user's name, age, gender, occupation, title, salary, phone number, physical address, email address, health history, identifier of a government issued identification document, payment instrument information (e.g., credit card number and expiration date), credit score, Internet Protocol (IP) address, shopping history at one or more shopping platforms, etc.

The method 1100 includes a step 1120 to embed, via an embedding module, the data of the first type into an electronic database. In some embodiments, the embedding is performed at least in part using an autoencoder function of the embedding module. In some embodiments, the embedding obfuscates the data of the first type. In some embodiments, the data of the first type is embedded in a manner such that the embedded data of the first type is inaccessible for a user of the electronic database. In some embodiments, the data of the first type is embedded in a manner such that it is irreversible after being embedded. For example, the embedded data cannot be converted back into the original data of the electronic file via an application of a function or an algorithm. In some embodiments, the data of the first type is in a non-numeric-vector format, and the embedding of step 1120 is performed by converting the data of the first type from the non-numeric-vector format into a numeric-vector format. In some embodiments, the electronic database includes a plurality of different partitions, and the embedding step of 1120 is performed at least in part by electronically storing different portions of the data of the first type in the different partitions of the electronic database.

The method 1100 includes a step 1130 to access, after the embedding, a request to query the data of the first type.

The method 1100 includes a step 1140 to add, based on the request to query the data of the first type, noise to an embedded data of the first type via a noise module. In some embodiments, the noise module introduces the noise to the embedded data of the first type at least in part using a batching technique.

The method 1100 includes a step 1150 to output the data of the first type after the noise has been added to the first type of data. In some embodiments, the data of the first type outputted is in a numeric vector format. In some embodiments, the data of the first type after the noise has been added is accessible to the user of the electronic database.

The method 1100 includes a step 1160 to perform a machine learning process at least in part based on the outputted data of the first type by step 1150 after the noise has been added.

The method 1100 includes a step 1170 to determine an overall characteristic of the data of the first type based on a result of the machine learning process performed by step 1160.

In some embodiments, the steps 1130, 1140, 1150 may be repeated a plurality of times. A different amount of noise or a different type of noise is added each time of the plurality of times, such that the data of the first type outputted is different each time of the plurality of times.

In some embodiments, one or more of the steps 1110-1170 are performed by a computer system of a first entity, the computer system including one or more hardware electronic processors. In some embodiments, the electronic file is provided to the first entity by a second entity different from the first entity.

It is also understood that additional method steps may be performed before, during, or after the steps 1110-1170 discussed above. For example, the method 1100 may include a step of determining an optimum level of noise to be added in the step 1140. For reasons of simplicity, other additional steps are not discussed in detail herein.

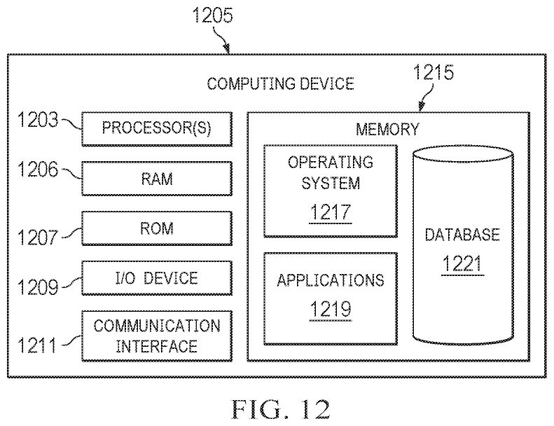

Turning now to FIG. 12, a computing device 1205 that may be used with one or more of the computational systems is described. The computing device 1205 may be used to implement various computing devices discussed above, including but not limited to, the data-embedding and noise-addition module 198, the data-embedding sub-module 220, or the noise-addition sub-module 240. The computing device 1205 may include a processor 1203 for controlling overall operation of the computing device 1205 and its associated components, including RAM 1206, ROM 1207, input/output device 1209, communication interface 1211, and/or memory 1215. A data bus may interconnect processor(s) 1203, RAM 1206, ROM 1207, memory 1215, I/O device 1209, and/or communication interface 1211. In some embodiments, computing device 1205 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 1209 may include a microphone, keypad, touch screen, and/or stylus motion, gesture, through which a user of the computing device 1205 may provide input, and may also include one or more speakers for providing audio output and a video display device for providing textual, audiovisual, and/or graphical output. Software may be stored within memory 1215 to provide instructions to processor 1203 allowing computing device 1205 to perform various actions. For example, memory 1215 may store software used by the computing device 1205, such as an operating system 1217, application programs 1219, and/or an associated internal database 1221. The various hardware memory units in memory 1215 may include volatile and nonvolatile, removable and non-removable media implemented in any method or technology for storage of information such as computer-readable instructions, data structures, program modules, or other data. Memory 1215 may include one or more physical persistent memory devices and/or one or more non-persistent memory devices. Memory 1215 may include, but is not limited to, random access memory (RAM) 1206, read only memory (ROM) 1207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 1203.

Communication interface 1211 may include one or more transceivers, digital signal processors, and/or additional circuitry and software for communicating via any network, wired or wireless, using any protocol as described herein.

Processor 1203 may include a single central processing unit (CPU), which may be a single-core or multi-core processor, or may include multiple CPUs. Processor(s) 1203 and associated components may allow the computing device 1205 to execute a series of computer-readable instructions to perform some or all of the processes described herein. Although not shown in FIG. 5, various elements within memory 1215 or other components in computing device 1205, may include one or more caches, for example, CPU caches used by the processor 1203, page caches used by the operating system 1217, disk caches of a hard drive, and/or database caches used to cache content from database 1221. For embodiments including a CPU cache, the CPU cache may be used by one or more processors 1203 to reduce memory latency and access time. A processor 1203 may retrieve data from or write data to the CPU cache rather than reading/writing to memory 1215, which may improve the speed of these operations. In some examples, a database cache may be created in which certain data from a database 1221 is cached in a separate smaller database in a memory separate from the database, such as in RAM 1206 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 1205 are described separately, functionality of the various components may be combined and/or performed by a single component and/or multiple computing devices in communication without departing from the invention.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the data-embedding and noise-addition module 198 may be implemented as such software code.

Based on the above discussions, it is readily apparent that systems and methods described in the present disclosure offer several significant advantages over conventional methods and systems. It is understood, however, that not all advantages are necessarily discussed in detail herein, different embodiments may offer different advantages, and that no particular advantage is required for all embodiments. One advantage is improved functionality of a computer. For example, conventional computer systems, even with the benefit of sophisticated hashing techniques, have not been able to sufficiently protect sensitive information such as users' private data. For example, even when sensitive data is hashed, it can still be reverse-engineered via a brute force type of attack to reveal the original sensitive information. The computer systems of the present disclosure overcome the vulnerabilities of conventional data-protection computer systems that use hashing methods in several ways. For example, the computer system of the present disclosure embeds sensitive information (e.g., name, address, phone number, etc.) by obfuscating the sensitive information (e.g., converting the user data from one format to another format) in a manner such that the embedded sensitive information cannot be readily converted back to the original format merely by applying a function or an algorithm to the embedded data. The embedded data is stored in an electronic database but remains inaccessible to the operator of the electronic database, which further reduces the likelihood of data leakage. In addition, since the embedded data is not available, it necessarily cannot be used in a brute-force type of reverse engineering attempt by malicious actors to uncover the original sensitive information.

Furthermore, based on received requests to query the embedded data, a noise-addition module adds noise to the embedded data before outputting the data. The addition of noise to the data further reduces the likelihood of a malicious actor being able to obtain the original sensitive data via reverse engineering. In addition, a different type or a different amount of noise is added to the same underlying sensitive attribute of the sensitive data for every query, which again diminishes the likelihood of a malicious actor being able to successfully hack into the original sensitive data. In this manner, the computer system of the present disclosure can protect sensitive information more effectively compared to conventional computer systems.

Another advantage is that the present disclosure may be compatible with machine learning even though the original sensitive information is protected and remains hidden. For example, based on a large number of noise-added data outputs (corresponding to a large number of data query requests), a machine learning process may be performed. The results of the machine learning process may reveal valuable insight with respect to one or more general characteristics about the underlying sensitive information. For example, a fraud trend or a purchasing trend of a certain type of users of a platform may be determined based on the machine learning results, all while the users' private data remains hidden. As such, the present disclosure can simultaneously achieve accurate predicative capabilities while still effectively protect data security.

The inventive ideas of the present disclosure are also integrated into a practical application, for example into the data-embedding and noise-addition module 198 discussed above. Such a practical application can be used to protect sensitive information, such as users' private data. The practical application further leverages the capabilities of machine learning to determine underlying characteristics and/or trends of particular groups of users, which then allows various entities to develop and/or implement marketing or business strategies accordingly. In addition, the practical application also allows one entity (e.g., a platform that collects the original sensitive information about its users) to confidently share the sensitive information with another entity, knowing that the shared sensitive information will be well-protected.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. According to the method, an electronic file is accessed. The electronic file contains a first type of data that meets one or more specified sensitivity criteria. Via an embedding module, the first type of data is embedded into an electronic database. After the embedding, a request to query the first type of data is accessed. Based on the request to query the first type of data, noise is added to an embedded first type of data via a noise module. The first type of data is outputted after the noise has been added to the first type of data.

Another aspect of the present disclosure involves a system that includes a non-transitory memory and one or more hardware processors coupled to the non-transitory memory and configured to read instructions from the non-transitory memory to cause the system to perform various operations. According to the operations, an electronic file is accessed. The electronic file contains sensitive data that is in a first format. The sensitive data meets a specified sensitivity threshold. At least in part via an encoder function, the sensitive data is converted from the first format into a second format that is different from the first format. The sensitive data, after being converted into the second format, is incapable of being converted back into the first format via an application of a function. Sensitive data is stored in an electronic database after the sensitive data has been converted. A request to access the sensitive data that was stored in the electronic database is received. Based on the request, noise-added sensitive data is generated. The noise-added sensitive data is in the second format but has different values than the sensitive data that was stored in the electronic database. The noise-added sensitive data is outputted.

Yet another aspect of the present disclosure involves a non-transitory machine-readable medium having stored thereon machine-readable instructions executable to cause a machine to perform various operations. According to the operations, an electronic file is accessed. The electronic file contains private user data that meets a predefined privacy threshold. The private user data has a first format. At least in part using an autoencoder function, the private user data is converted from the first format into a second format different from the first format. The converted private user data in the second format is stored into an electronic database. After the storing, a first request to query the stored converted private user data is received. Based on the first request, first noise-added data is outputted by applying a first type of noise or a first amount of noise to the stored converted private user data. After the storing, a second request to query the stored converted private user data is accessed. Based on the second request, second noise-added data is outputted by applying a second type of noise or a second amount of noise to the stored converted private user data. The second type of noise is different from the first type of noise, or the second amount of noise is different from the first amount of noise.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing an electronic file that contains data of a first type, the data of the first type meeting one or more specified sensitivity criteria;
embedding, via an embedding module, the data of the first type into an electronic database;
accessing, after the embedding, a request to query the data of the first type;
adding, based on the request to query the data of the first type, noise to embedded data of the first type via a noise module; and
outputting the data of the first type after the noise has been added.

2. The method of claim 1, wherein the noise module introduces the noise to the embedded data of the first type at least in part using a batching technique.

3. The method of claim 1, further comprising: repeating the accessing the request to query the data of the first type, the adding, and the outputting a plurality of times, wherein a different amount of noise or a different type of noise is added each time of the plurality of times, such that the data of the first type outputted is different each time of the plurality of times.

4. The method of claim 1, further comprising:
performing a machine learning process at least in part based on the outputted data of the first type after the noise has been added; and
determining an overall characteristic of the data of the first type based on a result of the machine learning process.

5. The method of claim 1, wherein the data of the first type outputted is in a numeric vector format.

6. The method of claim 1, wherein:
the data of the first type is embedded in a manner such that the embedded data of the first type is inaccessible for a user of the electronic database; and
the data of the first type after the noise has been added is accessible to the user of the electronic database.

7. The method of claim 1, wherein the data of the first type is embedded in a manner such that the data of the first type is irreversible after being embedded.

8. The method of claim 1, wherein the embedding is performed at least in part using an autoencoder function of the embedding module.

9. The method of claim 1, wherein the embedding obfuscates the data of the first type.

10. The method of claim 1, wherein:
the data of the first type is in a non-numeric-vector format; and
the embedding comprises converting the data of the first type from the non-numeric-vector format into a numeric-vector format.

11. The method of claim 1, wherein:
the electronic database includes a plurality of different partitions; and
the embedding comprises electronically storing different portions of the data of the first type in the different partitions of the electronic database.

12. The method of claim 1, wherein:
one or more of the accessing the electronic file, the embedding, the accessing the request to query the data of the first type, the adding the noise, or the outputting are performed by a computer system of a first entity, the computer system including one or more hardware electronic processors; and
the electronic file is provided to the first entity by a second entity different from the first entity.

13. A system, comprising:
a non-transitory memory; and
one or more hardware processors coupled to the non-transitory memory and configured to read instructions from the non-transitory memory to cause the system to perform operations comprising:
accessing an electronic file that contains sensitive data that is in a first format, the sensitive data meeting a specified sensitivity threshold;
converting, at least in part via an encoder function, the sensitive data from the first format into a second format that is different from the first format, wherein the sensitive data, after being converted into the second format, is incapable of being converted back into the first format via an application of a function;
storing the sensitive data in an electronic database after the sensitive data has been converted;
receiving a request to access the sensitive data that was stored in the electronic database;
generating, based on the request, noise-added sensitive data, wherein the noise-added sensitive data is in the second format but has different values than the sensitive data that was stored in the electronic database; and
outputting the noise-added sensitive data.

14. The system of claim 13, wherein the noise-added sensitive data is generated at least in part using a Batch Inference technique.

15. The system of claim 13, wherein the request to access the sensitive data is a first request, wherein the noise-added sensitive data comprises a first instance of the noise-added sensitive data, and wherein the operations further comprise:
receiving a second request to access the sensitive data that was stored in the electronic database; and
generating, based on the second request, a second instance of the noise-added sensitive data, wherein the second instance of the noise-added sensitive data is in the second format but has different values than both the sensitive data that was stored in the electronic database and the first instance of the noise-added sensitive data.

16. The system of claim 13, wherein the operations further comprise analyzing a trend associated with the sensitive data based on a machine learning process that is performed using the outputted noise-added sensitive data.

17. The system of claim 13, wherein:
the first format is a non-numeric-vector format; and
the second format is a numeric-vector format.

18. A non-transitory machine-readable medium having stored thereon machine-readable instructions executable to cause a machine to perform operations comprising:
accessing an electronic file that contains private user data that meets a predefined privacy threshold, the private user data having a first format;
converting, at least in part using an autoencoder function, the private user data from the first format into a second format different from the first format;
storing the converted private user data in the second format into an electronic database;
accessing, after the storing, a first request to query the stored converted private user data;
outputting, based on the first request, first noise-added data by applying a first type of noise or a first amount of noise to the stored converted private user data;
accessing, after the storing, a second request to query the stored converted private user data; and
outputting, based on the second request, second noise-added data by applying a second type of noise or a second amount of noise to the stored converted private user data, wherein the second type of noise is different from the first type of noise, or wherein the second amount of noise is different from the first amount of noise.

19. The non-transitory machine-readable medium of claim 18, wherein the stored converted private user data is inaccessible to an operator of the electronic database, and the first noise-added data or the second noise-added data is accessible to the operator of the electronic database.

20. The non-transitory machine-readable medium of claim 18, wherein the operations further comprise:
performing a machine learning process at least in part based on the first noise-added data and the second noise-added data; and
determining a pattern of the private user data based on a result of the machine learning process.
